(19) United States
(12) Patent Application Publication
(10) Pub. No.: US 2018/0319410 A1
(43) Pub. Date: Nov. 8, 2018

(54) Pre-Biased Delayed Emergency Release

(71) Applicant: Westinghouse Air Brake Technologies Corporation, Wilmerding, PA (US)

(72) Inventors: Andre Stojc, Ile Bizard (CA); Daniel Filion, Prevost (CA)

(21) Appl. No.: 15/773,312

(22) PCT Filed: Oct. 31, 2016
(86) PCT No.: PCT/US2016/059666

§ 371 Date: May 3, 2018

Related U.S. Application Data
(60) Provisional application No. 62/258,673, filed on Nov. 23, 2015.

(51) Int. Cl. B61D 19/02; E05B 47/00; E05B 79/20; E05B 83/36; E05F 15/40

(52) U.S. Cl. CPC B61D 19/023; B61D 19/026; E05B 47/0006; E05Y 2201/244; E05B 83/363; E05F 15/40; E05Y 2201/22; E05B 79/20

(57) ABSTRACT

The manual release mechanism described herein enables a passenger to attempt to manually open the transit door but delays opening until the vehicle is no longer moving. A motion transfer device (14) moves to an unlocking position of the door lock (10) only when the manual release mechanism is activated to release store energy in a mechanical energy storage device (40) and an electromechanical device (26) is de-energized to release the motion transfer device (14).

### CROSS REFERENCE TO RELATED APPLICATIONS

This application claims the benefit to U.S. Provisional Application No. 62/258,673 filed Nov. 23, 2015, the disclosure of which is hereby incorporated in its entirety by reference.

### BACKGROUND OF THE INVENTION

### Field of the Invention

This invention relates to a manual emergency release mechanism for transit vehicle doors. It is essential that transit vehicle doors be locked during normal operation while the vehicle is moving so that a passenger leaning against or falling against the door does not push open the doors and fall out of the vehicle. However, in an emergency, there must be a provision for unlocking the door. Certain Transit Authority operational procedures require the train to have reached full stop prior to allowing the doors to be unlocked, even in an emergency situation.

In the case of emergency, a passenger actuates a release handle. The handle (rotating or linear motion) pulls on a release cable. The release cable is connected to the door lock actuator mechanism to unlock the door.

The manual release mechanism described herein enables a passenger to attempt to manually open the transit door but delays opening until the vehicle is no longer moving.

### Description of Related Art

FIG. 4 illustrates one of many types of transit vehicle doors. Specifically, FIG. 4 is a plan view of a typical slide-glide door. The door panels 50 move from the closed position to an open position generally perpendicular to the closed position. The door panels 50 are hung from a track 51 that is parallel to the closed door by follower 52. The door is caused to open by rotation of door post 56 connected to the leading edge (when opening) by lever 57 extending from the door post. The door post is caused to rotate by door operator 53 via connecting rod 54 and bell crank 55.

A door lock may be associated with any number of the elements from the door operator to the door post and door panel.

Usually, a manual release cable is coupled directly to the lock actuator mechanism and the door panels become unlocked when the cable is pulled. Unfortunately, if the train is still moving, stopped between stations, or the door is on the wrong side of the vehicle while adjacent a station platform, if the door is manually unlocked, the passenger could get injured.

In the past, to prevent a passenger from leaving the car when unsafe to do so after the release handle has been actuated, the motor driving the doors was energized to attempt to keep the doors closed. However, the passenger with extra force can still force the doors open as the motors can only apply a limit amount of resistance force. Driving the doors in the closed position can cause the motors to overheat to their detriment. Also, the passenger can damage the door control mechanism when forcing the doors.

Also, in the past, a mechanism was provided to prevent the release handle from being moved so long as it is unsafe and, thus, the release cable from being pulled. However, this can frustrate the passenger and result in the handle being broken by the application of too much force. Also, when safe to do so, the passenger must again actuate the release handle. He must know when it is safe to do so.

### SUMMARY OF THE INVENTION

Briefly, according to this invention, there is provided an emergency manual door lock release mechanism for releasing a door lock actuator mechanism on a transit vehicle door comprising: a motion transfer device, an electromechanical device for fixing the position of the motion transfer device when energized and releasing the motion transfer device when de-energized, a mechanical energy storage device, connections for energizing the mechanical energy storage device to bias the motion transfer device to move to an unlocking position upon closing of the transit door, a detent mechanism normally capturing the motion transfer device and releasing the motion transfer device when the detent mechanism is activated such that the door lock actuator mechanism will only be manually released when the detent mechanism is activated and the electromechanical device is de-energized to release the motion transfer device.

The motion transfer device may, for example, be a slide connected to a cable or lever connected to the door lock. The mechanical energy storage device may, for example, be a coil spring. The electromechanical device may, for example, be an electromagnet or solenoid. The manual release device may, for example, be a handle, cable, lever, or combination thereof.

Briefly, according to a specific embodiment of this invention, an emergency manual door lock release mechanism for releasing a door lock on a transit vehicle door comprises: a base plate for being secured to the transit vehicle, and a sliding plate abutting and moveable relative to the base plate. The sliding plate has at least one elongate slot. At least one pin fixed to the base plate extends into the at least one elongate slot constraining the relative movement between the base plate and sliding plate in a lateral direction.

A first end bracket is secured to the base plate at or near one lateral end of the base plate. An electromagnet is secured thereto. The first end bracket has an aperture therein for receiving a manual release Bowden cable. A second end bracket is secured to the base plate at or near the lateral end opposite from the first end bracket.

A bracket fixed to the sliding plate supports a magnetizable steel plate in a position to be captured by the electromagnet. A coil spring that stores energy upon closing of the door is biased to move the sliding plate away from the electromagnet. The coil spring is connectable to a device associated with the door for storing energy in the coil spring upon closing of the door. The coil spring is anchored directly or indirectly at one end to the second end bracket and is connected at the other end directly or indirectly to the bracket supporting the magnetizable plate. A detent mechanism fixed to the base plate normally captures the sliding plate and releases the sliding plate when the manual release cable is pulled. A motion transfer device is connected to the sliding plate such that when the sliding plate moves away from the electromagnet, the door lock will be released only when the manual release cable is pulled to release the detent mechanism and the electromagnet is de-energized to release the magnetizable steel plate.

The electromagnet electrical power is typically under the control of an ON/OFF signal issued by a combination of the train berthing system and the zero-speed system. When the train is properly berthed and at zero speed, the electromagnet is de-energized. It is energized whenever these conditions are not met.

Also, typically, there is a separate pull cable on the door lock actuating mechanism (not shown) allowing the door to be unlocked in normal service independently of the emergency release.

### BRIEF DESCRIPTION OF THE DRAWINGS

Further features and other objects and advantages of the invention will become apparent from the following detailed description made with reference to the drawings.

FIG. 1 is a schematic and prospective view of an emergency manual door lock release mechanism for releasing a door lock on a transit vehicle according to this invention when release is not actuated.

FIG. 2 is a schematic and prospective view of an emergency manual door lock release mechanism for releasing a door lock on a transit vehicle according to this invention when manual release has been attempted but the door lock is not released.

FIG. 3 is a schematic and prospective view of an emergency manual door lock release mechanism for releasing a door lock on a transit vehicle according to this invention when manual release has been attempted and the door lock has been released.

FIG. 4 is a plan view of a typical slide-guide door on a transit vehicle.

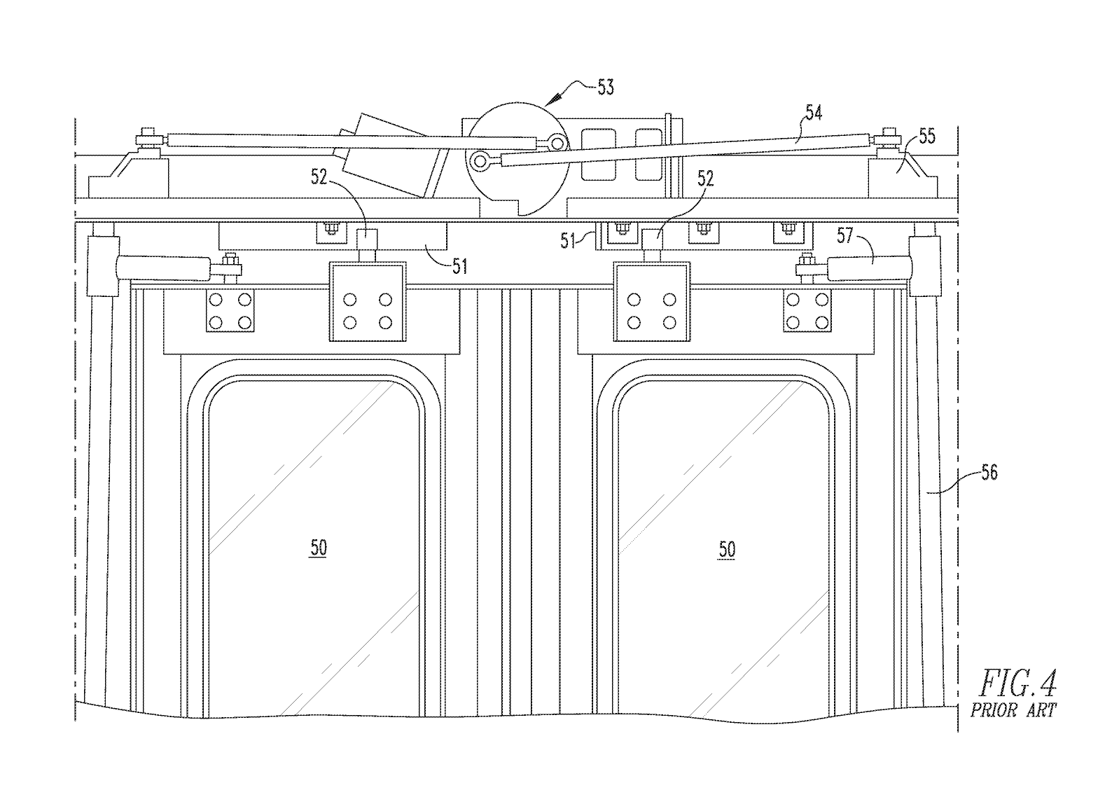

### DESCRIPTION OF THE INVENTION

Referring now to the drawings, an emergency manual door lock release mechanism for releasing a door lock comprises: a base plate 12 for being secured to the transit vehicle, and a sliding plate 16 abutting and moveable relative to the base plate 12. The sliding plate 16 has at least one elongate slot 20. At least one pin 22, 24 fixed to the base plate extends into the at least one elongate slot constraining the relative movement between the base plate and sliding plate in a lateral direction indicated by the double head arrow.

A first end bracket 26 is secured to the base plate at or near one lateral end of the base plate. An electromagnet 28 is secured thereto. The first end bracket has an aperture therein for receiving a manual release Bowden cable 30. A second end bracket 32 is secured to the base plate at or near the lateral end opposite from the first end bracket 26.

A bracket 34 fixed to the sliding plate supports a magnetizable steel plate 36 in a position to be captured by the electromagnet 28. A coil spring 40 that stores energy when compressed upon closing of the door is biased to move the sliding plate 16 away from the electromagnet 28. The coil spring is anchored directly or indirectly at one end to the second end bracket 32 and is connected at the other end directly or indirectly to the magnetizable plate bracket 34.

A detent mechanism 38 fixed to the base plate 12 normally captures the sliding plate 16 and releases the sliding plate when the manual release cable 42 is pulled. The sliding plate 16 is directly or indirectly connectable to the door lock such that when the sliding plate moves away from the electromagnet 28 the door lock will be released. The door lock will only be released when the manual release cable 30 is pulled to release the detent mechanism 38 and the electromagnet 28 is de-energized to release the magnetizable steel plate 34.

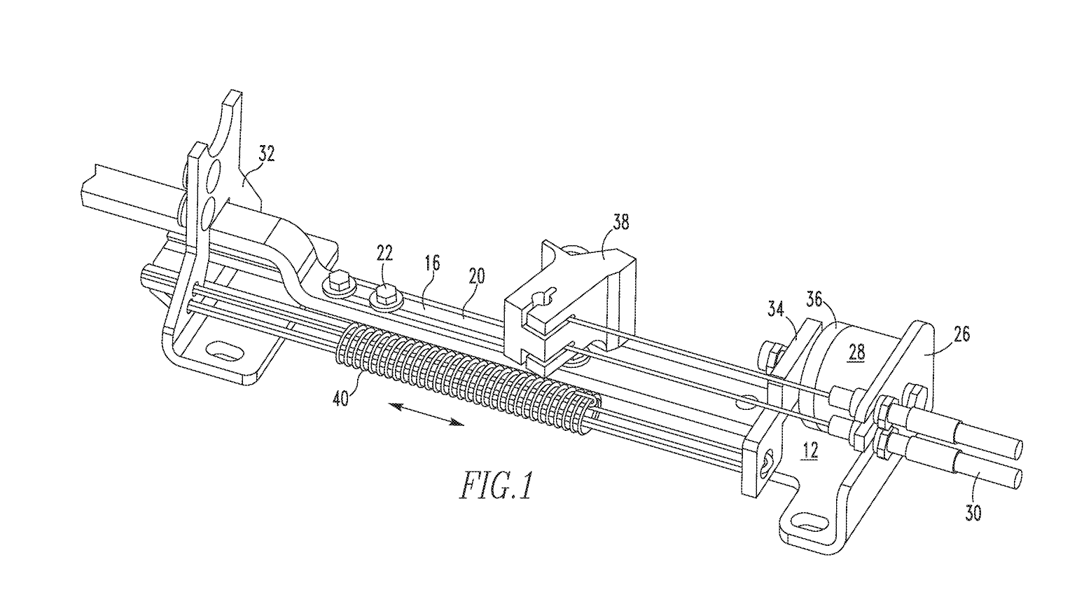

Referring to FIG. 1 sliding plate 16 is retracted. The coil spring 40 is stretched to store energy to bias the sliding plate 16 away from the electromagnet 28, the electromagnet 28 is energized capturing the magnetizable steel plate 36, and the detent mechanism 38 has captured the sliding plate 16. This is the condition when the transit vehicle is moving between stations.

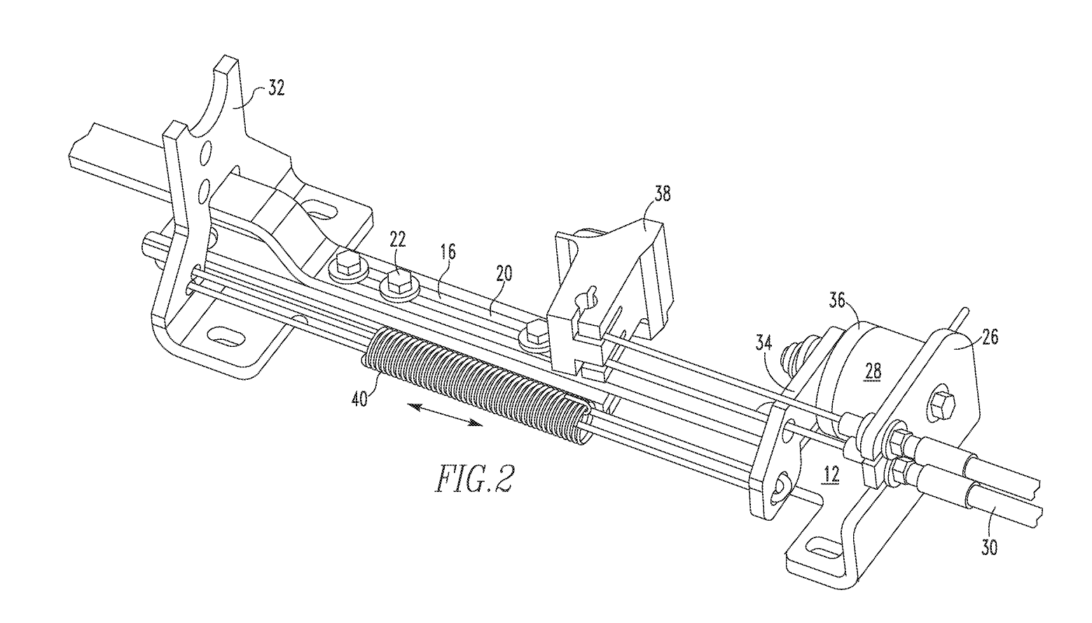

Referring to FIG. 2, the emergency manual door lock release mechanism is shown when manual release has been attempted but the door lock is not released. The manual release cable 30 has been pulled and the detent mechanism 38 has been disengaged from the sliding plate 16. The coil spring 40 remains energized and the electromagnet 28 remains energized to hold the magnetizable steel plate 36 and, therefore, the sliding plate 16 in the retracted position. This is the condition when a passenger has attempted manual release and, for example, the transit vehicle is still moving.

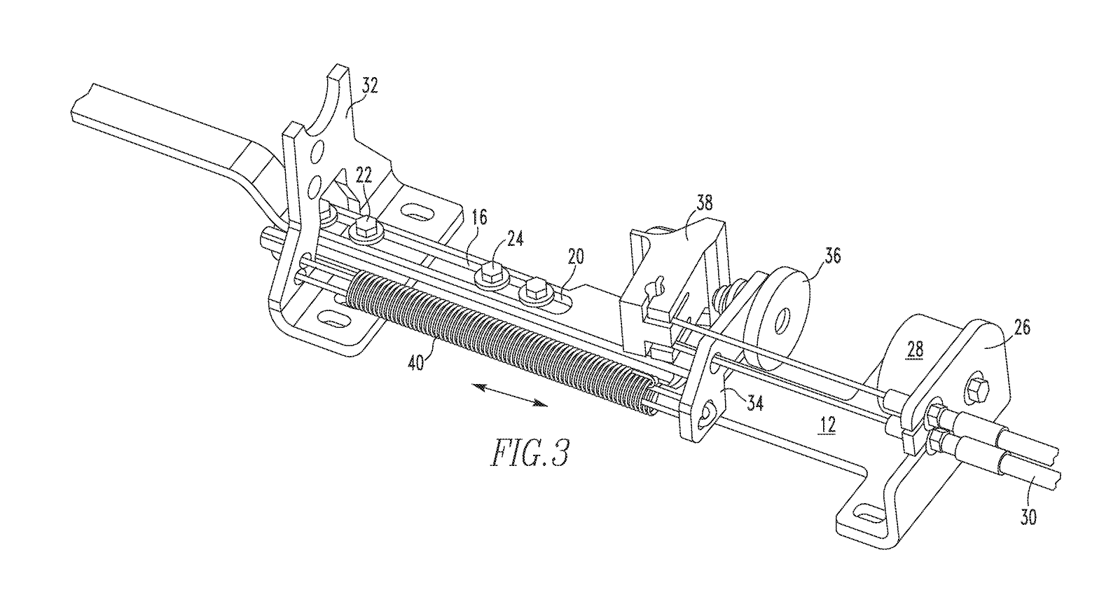

Referring to FIG. 3, manual release has been attempted and the door lock has been released. The electromagnet 28 is no longer energized and the magnetizable steel plate 36 has been freed. The coil spring 40 has use stored energy to move the sliding plate 16 to its fully extended position such that the door release mechanism has unlocked the door lock so that passengers can escape the transit vehicle.

Having thus defined our invention with the detail and particularity required by the Patent Laws, what is desired protected by Letters Patent is set forth in the following claims.

The invention claimed is:

1. An emergency manual door lock release mechanism for releasing a door lock on a transit vehicle door comprising: motion transfer means, an electromechanical device for fixing the position of the motion transfer means when energized and releasing the motion transfer means when de-energized, a mechanical energy storage means, means for energizing the mechanical energy storage means to bias the motion transfer means to move to a unlocking position upon closing of the transit door, a detent mechanism normally capturing the motion transfer means and releasing the motion transfer means when the detent mechanism is activated to release the motion transfer means such that the door lock will only be manually released when the detent mechanism is activated and the electromechanical device is de-energized to release the motion transfer means.

2. An emergency manual door lock release mechanism for releasing a door lock on a transit vehicle door comprising: a base plate for being secured to the transit vehicle, a sliding plate abutting and movable relative to the base plate, said sliding plate having at least one elongate slot, at least one pin fixed to the base plate extending into the at least one elongate slot constraining the relative movement between the base plate and sliding plate in a lateral direction, an electromagnet, a manual release cable, a first end bracket secured to the base plate at or near one lateral end of the base plate and having the electromagnet secured thereto, said first end bracket having an aperture therein for receiving the manual release cable, a second end bracket secured to the base plate at or near the lateral end opposite from the first end bracket, a magnetizable steel plate, a bracket fixed to the sliding plate and supporting the magnetizable steel plate in a position to be captured by the electromagnet, a coil spring that stores energy upon closing of the door to bias the spring to move the sliding plate away from the electromagnet, said coil spring anchored directly or indirectly at one end to the second end bracket and connected at the other end directly or indirectly to the bracket supporting the magnetizable steel plate, a detent mechanism fixed to the base plate that normally captures the sliding plate and releases the sliding plate, the sliding plate being connected directly or indirectly to the lock such that when the manual release cable is pulled, the sliding plate moves away from the electromagnet, and the door lock will be manually released only when the manual release cable is pulled to release the detent mechanism and the electromagnet is de-energized to release the magnetizable steel plate.
